(19) United States
(12) Patent Application Publication
(10) Pub. No.: US 2015/0007041 A1
(43) Pub. Date: Jan. 1, 2015

(54) METHOD AND TECHNICAL EQUIPMENT FOR PROVIDING A USER INTERFACE IMPLEMENTATION

(71) Applicant: M-Files Oy, Tampere (FI)

(72) Inventors: Ari Metsapelto, Sastamala (FI); Antti Nivala, Pirkkala (FI); Mikko Rantanen, Tampere (FI); Timo Harju, Orivesi (FI); Jari Paija, Urjala (FI); Juha Lepola, Tampere (FI)

(21) Appl. No.: 13/927,573

(22) Filed: Jun. 26, 2013

(51) Int. Cl. G06F 3/048

(52) U.S. Cl. CPC G06F 3/048
USPC 715/744

(57) ABSTRACT

The present embodiments relate to a method and technical equipment for providing a user interface implementation of an electronic form in a client application. The user interface implementation is created by such computer program language structures that are compatible with both a native operating environment and a www operating environment, wherein the user interface implementation of the electronic form is the same in both operating environments. The user interface implementation defines both presentation and logics for the user interface.

### TECHNICAL FIELD

The present solution relates to a method and a technical equipment for providing a user interface implementation.

### BACKGROUND

Increasingly more client applications being installed in a client computer have also a web based version that provides the same data and similar functions of the application via web browser. Such a web based version is called as “web access”. The benefits of web access is that a user is not limited to use only the computer where the client application is being installed, but is able to other computers as well—as long as the other computer has a web browser. The user experience of using web browser compared to one of client application may—however—be different. This is because, web browser does not necessarily provide similar user interface than the client application.

There is a need for a solution that improves the user experience between different operating environments.

### SUMMARY

Now there has been invented an improved method and technical equipment implementing the method, by which the user experience may be improved. Various aspects of the invention include a method, an apparatus and a computer readable medium comprising a computer program stored therein, which are characterized by what is stated in the independent claims. Various embodiments of the invention are disclosed in the dependent claims.

According to a first aspect, there is provided a method comprising providing a user interface implementation of an electronic form in a client application, which user interface implementation is created by such computer program language structures that are compatible with both a native operating environment and a www (web-based) operating environment, wherein said user interface implementation of the electronic form is the same in both operating environments.

According to a second aspect, there is provided an apparatus comprising at least one processor, memory including computer program code, the memory and the computer program code configured to, with the at least one processor, cause the apparatus to perform at least the following: providing a user interface implementation of an electronic form in a client application, which user interface implementation is created by such computer program language structures that are compatible with both a native interface and a www interface, wherein said user interface implementation of the electronic form is the same in both operating environments.

According to a third aspect, there is provided a computer program product embodied on a non-transitory computer readable medium, comprising computer program code configured to, when executed on at least one processor, cause an apparatus or a system to: provide a user interface implementation of an electronic form in a client application, which user interface implementation is created by such computer program language structures that are compatible with both a native interface and a www interface, wherein said user interface implementation of the electronic form is the same in both operating environments.

According to an embodiment, the implementation for a user interface implementation utilizes Component Object Model (COM) interfaces in said native operating environment.

According to an embodiment, the user interface implementation is created with JavaScript.

According to an embodiment, also business logics controlling the user interface implementation has an implementation that is compatible with both operating environments.

According to an embodiment, the user interface implementation defines both presentation and logics for the user interface.

According to an embodiment, the language structure comprises also data structures.

### DESCRIPTION OF THE DRAWINGS

In the following, various embodiments of the invention will be described in more detail with reference to the appended drawings, in which

FIG. 1 shows an example of a system configuration for a document management system;

FIG. 2 shows an example of an electronic form;

FIG. 3 shows an embodiment of a first and second operating environments where a user interface implementation is provided;

FIG. 4 shows another embodiment of a first and second operating environments where a user interface implementation is provided; and

FIG. 5 shows an example of an apparatus according to an embodiment.

### DESCRIPTION OF EXAMPLE EMBODIMENTS

In the following, several embodiments of the invention will be described in the context of a document management system, i.e. electronic forms in a document management system. Parallel terms for document management system are “content management system”, “data management system”, “enterprise content management system”. An example of a document management system is M-files® document management system. It is to be noted, however, that the invention is not limited to the document management system. In fact, the different embodiments have applications in any environment where mediating between operating systems is required.

The document management system (DMS) refers to a file arrangement that stores objects being defined by metadata (i.e. properties). Such system comprises various features for managing electronic documents, e.g. storing, versioning, indexing, searching for and retrieval of documents. It is appreciated that there are both dynamic and static document management systems. The difference between dynamic and static systems is the way they store files. In the static systems files are stored e.g. in a constant treelike hierarchy that defines relationships for folders and documents stored in the tree. In the dynamic systems the files may be given identifications that define their existence in the system. The observed location of the files is not constant, but may vary in a virtual space depending on the situation.

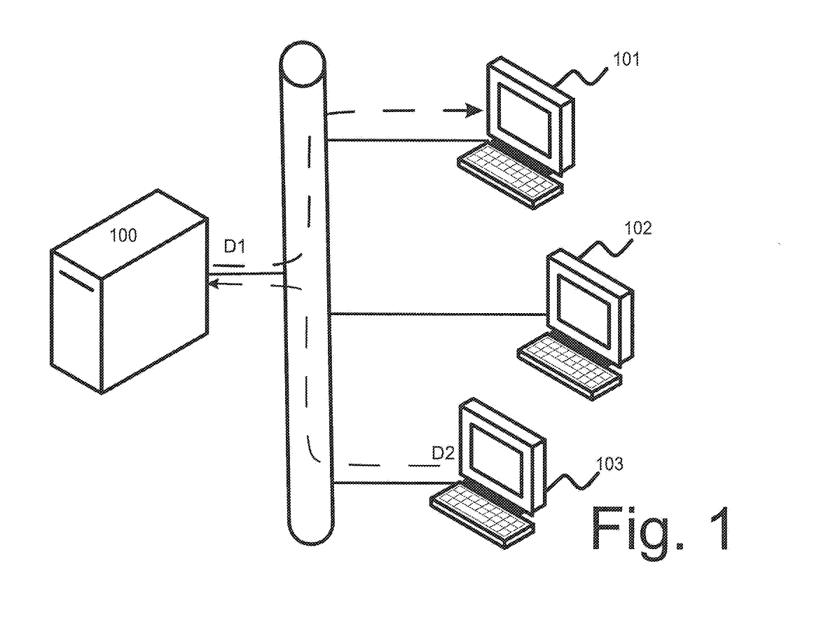

An example of a document management system configuration is illustrated in FIG. 1. The system comprises a document management server 100 and client devices 101, 102, 103, which are interconnected. The interconnection can be wired or wireless and it may be substantially always on or it may be disconnected occasionally. The server 100 is configured to store objects (e.g. documents) that can be retrieved by the client devices 101, 102, 103. The server and client devices each typically includes at least one processor and at least one memory (computer readable medium) for storage of at least computer program code for execution by the at least one processor. The client device can be any electronic device capable of computing, such as e.g. a personal computer, a laptop, a mobile device. Instead of the server 100, the document management system may comprise more than one servers, and at least one of these servers may be a cloud-based server while the others are so called “on-premise servers”. The client devices 101, 102, 103 may have different operating systems with respect to each other. For example, the client device 101 may have the Windows® operating system (later referred as “native”), whereas client device 102 has a WWW (World Wide Web) based operating environment and client device 103 operates on a mobile operating system (another example of “native”). It is also possible that any of the client devices have both the native and WWW based operating environments. The access from the client device to the document management system are provided according to the operating environment. In the native environment, the access to the document management server is provided by a native client application. In the WWW operating environment, the access to the document management server is provided by a browser having web access to the server. This means that if a user is not able to use his/her personal computing device into which the native client application is installed, the user may use a web browser of some other computing device and access the data in the document management system.

In the example of FIG. 1, a document D1 is retrieved by client device 101, whereas document D2 is stored by the client device 103 to the document management server 100. The document management server 100 is configured mainly to store documents, but in use the document management server may have other functions as well, e.g. it may control access rights, register modifications made to documents and allow connections to other systems.

As was mentioned, the document management system can be dynamic so that the folders are virtual, and the documents are virtually located in the folders depending on the user's viewpoint that builds on top of metadata. The present embodiments can however be utilized in a file management system statically storing folders that comprise files. Documents can have more than one location in the dynamic document management system but the document as such is the same document throughout the locations. In other words, the document is stored into the document management system only once, but is given multiple locations based on its metadata items. Therefore, term “location” should be interpreted as both a physical and a virtual location depending on the file arrangement to cover both dynamic document management system and file management system. However, in order to utilize the present solution, the objects (e.g. documents, folders) have to be associated with metadata. This means that each e.g. document has a property structure defining at least one piece of metadata (i.e. metadata item) for the document.

An electronic document stored in the document management system is an example of an object. Such an object is defined with metadata comprising e.g. a name of creator, a type of a document, a project which the document belongs to, a security class, a client etc.

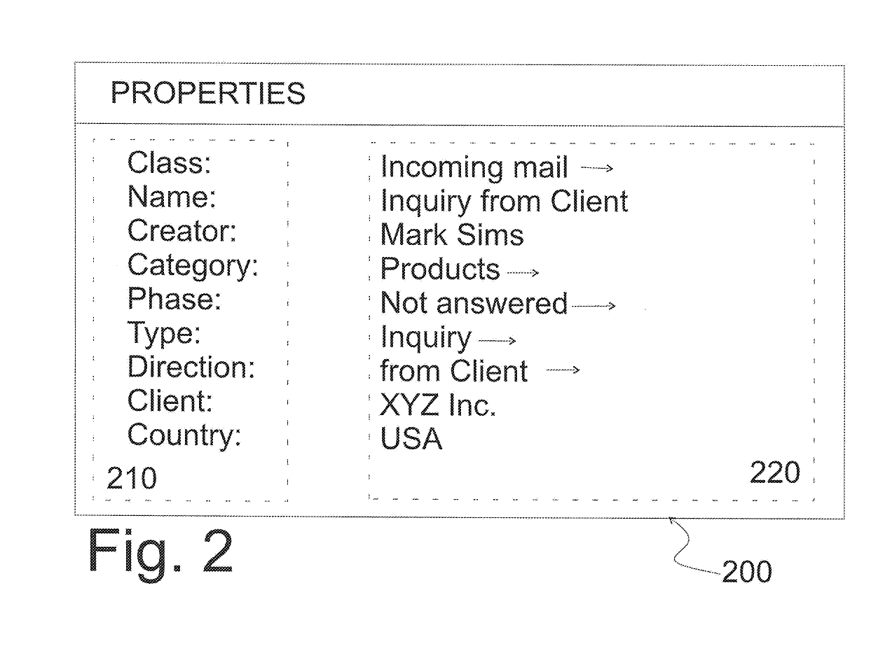

The metadata (a.k.a. property/properties) is composed of a definition part and a value. The definition part defines which property (i.e. metadata item/piece of metadata) is in question, e.g. “name”, “client”, “type”, “project”, “date”, etc. The value defines the specific value for the property, e.g. “John Smith”, “ABC Ltd”, “Offer”, “Project B”, “30.6.2013” respectively. The metadata can be represented for electronic objects by means of a “metadata card”, which displays a selection of metadata items. The metadata card may have fixed properties that are included automatically (e.g. creating time), and modifiable properties. An example of a metadata card is shown in FIG. 2. In FIG. 2, the definition part 210 and the value part 220 has been differentiated. The definition part 210 has selectable metadata items (Class; Name; Creator; Category; Phase; Type; Direction; Client; Country), and the value part 220 specifies the values (Incoming mail; Inquiry from Client; Mark Sims; Products; Not answered; Inquiry; from Client; XYZ Inc.; USA) for the metadata items. Some of the values are selectable from a selection list (marked with an arrow) and some of the values may be typed by a user. In this disclosure a metadata card is used as an embodiment, however, it is appreciated that the teachings of the present invention can be applied for other electronic forms also. The metadata selection for a certain metadata card can be determined by a user. This means that the user is able to select from a predefined list of properties such properties that are important for an electronic object in question.

As said, a metadata card can be used for metadata input. However, the metadata card can also be used for reading the metadata. For example, the content of the metadata card can be automatically presented with the electronic object on a user interface view of the client application. Yet in other embodiments, the metadata card can be extended with additional features targeted to a certain use case. For example, metadata card can have a user interface that is tailored for a certain use. As an example of this, the metadata card can look like an invoice, whereby data for the invoice can be input by the metadata card. As another example, the metadata can be input by using an address book, which is an example of data originating from an integrated system. Yet as another example, metadata of a plurality of interconnected objects can be input simultaneously by the metadata card. As an example of such a use, the same metadata card can be used to input data relating both to order confirmation and breakdown of ordered items. Yet as another example, branding of a product and resulting customization and changes in the appearance can be defined by a metadata card.

As described, the document management server can be accessed from different operating environments. According to an embodiment, one of the operating environments is a so called “native” operating environment, which refers to a local operating system being installed on a computer having a client application of a client-server system. According to an embodiment, the other of the operating environments is WWW having web access for the client-server system. Typically the metadata cards (i.e. implementation and presentation, i.e. the logic and the appearance of the metadata cards) in these operating environments are different. However, for the sake of usability, the look-and-feel of the differently accessed applications/document management data should be substantially the same.

Therefore, the present embodiments are aimed to improve the usability of different elements in various operating environments, and especially to improve the usability of electronic forms (metadata card as an example) so that the implementation of the electronic form is the same in different operating environments. In this disclosure, term “implementation” is a general term covering both user interface presentation (i.e. appearance) and logics. The teachings of the present embodiments can, however, be utilized for other user interface elements as well.

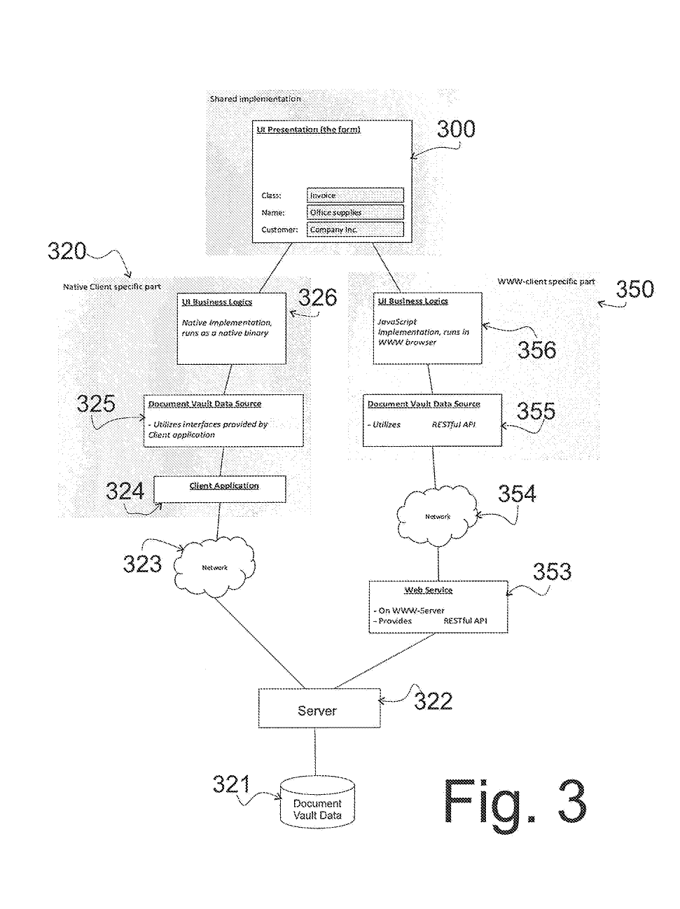

An embodiment of a present invention is described next. FIG. 3 illustrates an example of two operating environments: one with native client 320 and one with WWW client 350. The form (e.g. a metadata card) with metadata items has a certain kind of a user interface (UI) presentation 300. The implementation of the user interface presentation 300 is shared by the operating environments. This means that the file of the form is not shared by the two operating environments but the source files (a.k.a. implementation files) of the form. Source files can contain the source code, content data, stylesheets, and any other files that generate the form in question. The form can be implemented with JavaScript™ and run in WWW (World Wide Web) browser, but also some other programming language can be used such as JScript or other ECMAScript dialect, for example. In this example the form has metadata definitions “Class”, “Name” and “Customer”. The values for the metadata are “Invoice”, “Office supplies” and “Company Inc.” respectively.

Because of the shared implementation, the UI presentation 300 of the electronic form can be displayed in two different operating environments so that the UI presentation 300 is the same in both of them. Both the native environment 320 and the WWW environment 350 have a respective UI Business Logics 326, 356, which are utilized by the UI Presentation 300. The UI Business Logics 326 of the native environment 320 has a native implementation and it runs as a native binary code. The UI Business Logics 356 of the WWW environment 350 has a JavaScript implementation (for example) and it runs in WWW browser. The electronic form is presented in a client application in both environments. In WWW environment, the WWW client already operates in a browser, but in the native environment the native client shows the UI presentation of the form in a browser component being integrated in the client application.

In the native environment 320, the client application 324 of the document management system accesses through a network 323 the document management server 322, which obtains data from document vault 321.

In the WWW environment 350, the document management system's web service 353 is located on a WWW server and provides an interface utilizing HTTP/HTTPs. An example of the interface is RESTful API. The web service 353 is connected to the document management server 322, which obtains data from document vault 321.

In order to achieve a same UI implementation of an electronic form for two different operating environments, the similarity of JavaScript and native COM (Component Object Model) interfaces is utilized. COM interfaces (also known as ActiveX interface) may comprise OLE Automation Interface or IDispatch interface. In this embodiment, the visibility of the COM interfaces in a web browser (e.g. Internet Explorer) to a JavaScript application is such that such an application (e.g. an electronic form) can be created, which does not know which interface utilizes the functionality—is it a JavaScript program module interface or a COM interfaces provided outside the browser. Therefore, the electronic form may be implemented in such a manner that it utilizes the JavaScript implementation in WWW environment and the COM interfaces (in an integrated web browser) in native environment and therefore has the same UI implementation in both environments. The implementation of the electronic form is based on such language structures (i.e. syntax, semantics) of the programming language (e.g. JavaScript) which are compatible for both interfaces (i.e. COM interfaces, JavaScript interface). In other words, for implementing the electronic form, such language structures are avoided which are not compatible for both interfaces. Language structures also cover data structures that need to be compatible for both interfaces. This means that any data structure being designed for the user interface needs to be compatible for both environments.

According to an embodiment, the shared data structures in native operating environment are implemented as COM objects, whereas the shared data structures in WWW operating environment are implemented as JavaScript objects. The data structures are designed so that they can be used in similar manner, without knowing if they origin from native or www environment.

It is appreciated that the previous example of COM and JavaScript was provided for understanding purposes only. However, regardless of the actual implementation, it is more important to arrange the data transfer so that the data source can be a HTTP/HTTPs server at the other end of the data transfer path, or the data source can be a component of a local device behind a programming interface, whereby the metadata card (i.e. the electronic form) does not need to know which one of them is used. This means that a UI presentation is implemented with HTML/JavaScript. Such a UI implementation is provided with a business logic layer, which in a browser (WWW) environment can be implemented with JavaScript, and in a native environment the business logic layer is either implemented with JavaScript or a COM interface is given to the UI implementation, which COM interface functions in a similar manner than JavaScript. In WWW environment the UI implementation is executed in a browser locally, but if an external data is needed, then HTTP/HTTPs protocol is utilized.

The browser environment is configured differently in different operating environments. In WWW environment, a browser is loaded with a logic (UI Business Logics 356) that controls the UI functionality 300. Also the browser is loaded with an interface “Document Vault Data Source” 355 that models the content of the document vault 321. This interface 355 uses as its data source services 353 offered by the WWW server being provided over HTTP/HTTPs protocol e.g. as so called RESTful API service.

In the native environment, the integrated browser is augmented with an interface (UI Business Logics 326) that controls the UI functionality 300. This on the other hand uses the client application 324 as its data source through a document Vault Data Source 325 utilizing interfaces provided by the client application 324. This kind of an operation deviates from the normal operation of the browser in such a way that the browser does not use the normal data retrieval channel over the HTTP/HTTPs protocol, but it obtains all dynamic content by using the interface.

In the following a use case relating to the above embodiment is discussed as an example. In this use case, a header of an object (i.e. header of a document) is provided to (i.e. displayed in) the UI presentation 300. In the example of FIG. 3, the header can be created from metadata value of metadata “Class” , i.e. “Invoice”.

In the native environment, the UI presentation 300 queries the content of the header field from the UI Business Logics component 326. The UI Business Logics component 326 is implemented as native component of the client application 324. The native component determines which feature acts as the header feature of the object in question and determines the actual header. In this example, the feature acting as a header feature is a metadata “Class” and the actual header is thus “Invoice”. For determining these, the native component performs queries from the document management system's client application 324. The needed information may be determined internally in the document management system's client application 324, because the header may be stored in the internal cache of the client application 324. The result is returned to the UI Presentation component 300 in such a form that it can be directly displayed in a user interface.

The same operation in WWW environment is described next. The UI presentation 300 queries the content of the header field from the UI Business Logics component 356. In this example, the UI Business Logics component 356 is implemented with JavaScript in the same browser. The JavaScript implementation determines, which feature (i.e. “Class”) appears as a header field of the object in question and determines the actual header (i.e. “Invoice”). For determining these, the component 356 performs queries by using e.g. RESTful API interface 355. The queries are targeted over the HTTP/HTTPs protocol to a WWW server 353 which may address them further to the document management server 352. The result, i.e. the header, is returned to UI Presentation component 300 in such a form that it can be directly displayed in a user interface.

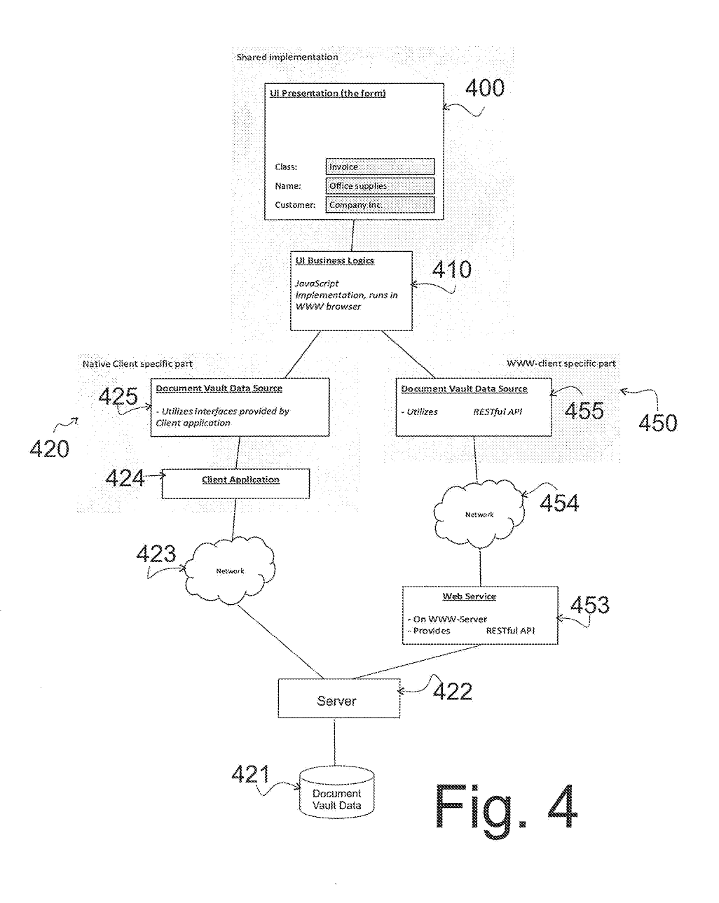

In the previous embodiment a user interface implementation (i.e. presentation and logics) is the same in two operating environments. There, both environments have their own UI Business logics implementations for achieving the same UI implementation. In a further embodiment, the business logics implementation may also be the same, as shown in FIG. 4. The difference of FIG. 4 compared to FIG. 3 is that the UI Business Logics implementation 410 is a shared implementation for native environment and WWW environment. The UI Business Logics may be implemented by JavaScript and run in WWW browser in a same way as the UI presentation (i.e. utilizing the COM interface). The purpose of the UI Business Logics 410 is to control the UI functionality, and perform the data queries from the document vault 421, 451. Other components—i.e. Document Vault Data Source 425, 455; Client Application 424; network 423, 454; Document management system's Web Service 453; Document management system's Server 422, 452—function as in the example of FIG. 3.

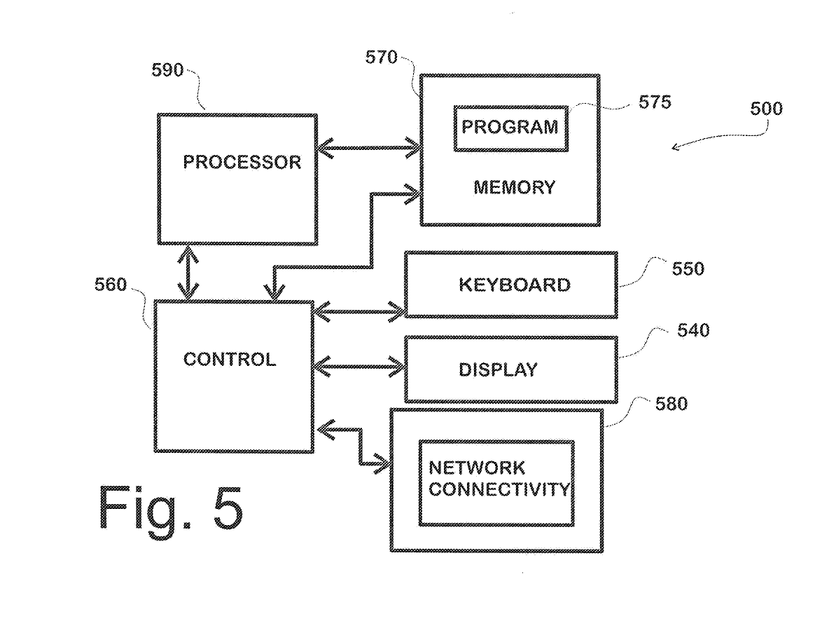

FIG. 5 illustrates an electronic apparatus according to an embodiment. The apparatus 500 comprises a processor 590 (Central Processing Unit, CPU) for processing data, and memory 570 that may store applications and various data. The apparatus also comprises a computer program code 575 that resides in the memory 570. The memory 570 can be, but is not limited to, a single memory, CD, DVD, ROM, RAM, EEPROM, optical storage, or any non-volatile storage medium capable of storing digital data.

The apparatus also comprises a control unit 530 for controlling functions in the apparatus 500. The control unit 530 (MCU, Main Control Unit) may comprise one or more processors. The control unit 530 may run a user interface software to facilitate user control of at least some functions of the apparatus 500. The control unit 530 may also deliver a display command and a switch command to a display 540 to display (i.e. to provide) visual information, e.g. a user interface presentation. The apparatus may also comprise a keyboard 550 for receiving input from a user. The control unit 530 may also communicate with the processor 590.

Yet further, the apparatus 500 may contain various communication means, e.g. a network connectivity 580 having a transmitter and a receiver for connecting network and for sending and receiving information.

The apparatus may be a client apparatus of a document management system and be in contact with the document management server. A client application of the document management system may be stored in the memory of the apparatus. The UI implementation of an electronic form may be generated dynamically in the client application according to the source data, source code, stylesheets, content data, etc. The client application can be either native client application or www client application having web access to the document management system. The server of the document management system may comprise circuitry and electronics for handling, receiving and transmitting data, computer program code in a memory, and a processor that, when running the computer program code, causes the server device to carry out the features of an embodiment.

The various embodiments of the invention can be implemented with the help of computer program code that resides in a memory and causes the relevant apparatuses to carry out the invention. It is obvious that the present invention is not limited solely to the above-presented embodiments, but it can be modified within the scope of the appended claims.

What is claimed is:

1. A method comprising
providing a user interface implementation of an electronic form in a client application, which user interface implementation is created by such computer program language structures that are compatible with both a native operating environment and a www operating environment, wherein said user interface implementation of the electronic form is the same in both operating environments.

2. The method according to claim 1, wherein the user interface implementation utilizes Component Object Model (COM) interfaces in said native operating environment.

3. The method according to claim 1, wherein the user interface implementation is created with JavaScript.

4. The method according to claim 1, wherein also business logics controlling the user interface implementation has an implementation that is compatible with both operating environments.

5. The method according to claim 1, wherein the user interface implementation defines both presentation and logics for the user interface.

6. The method according to claim 1, wherein the language structure also comprises data structures.

7. An apparatus comprising at least one processor, memory including computer program code, the memory and the computer program code configured to, with the at least one processor, cause the apparatus to perform at least the following:
providing a user interface implementation of an electronic form in a client application, which user interface implementation is created by such computer program language structures that are compatible with both a native interface and a www interface, wherein said user interface implementation of the electronic form is the same in both operating environments.

8. The apparatus according to claim 7, wherein the user interface implementation utilizes Component Object Model (COM) interfaces in said native operating environment.

9. The apparatus according to claim 7, wherein the user interface implementation is created with JavaScript.

10. The apparatus according to claim 7, wherein also business logics controlling the user interface implementation has an implementation that is compatible with both operating environments.

11. The apparatus according to claim 7, wherein the user interface implementation defines both presentation and logics for the user interface.

12. The apparatus according to claim 7, wherein the language structure also comprises data structures.

13. A computer program product embodied on a non-transitory computer readable medium, comprising computer program code configured to, when executed on at least one processor, cause an apparatus or a system to:
provide a user interface implementation of an electronic form in a client application, which user interface implementation is created by such computer program language structures that are compatible with both a native interface and a www interface, wherein said user interface implementation of the electronic form is the same in both operating environments.

14. The computer program product according to claim 13, wherein the user interface implementation utilizes Component Object Model (COM) interfaces in said native operating environment.

15. The computer program product according to claim 13, wherein the user interface implementation is created with JavaScript.

16. The computer program product according to claim 13, wherein also business logics controlling the user interface implementation has an implementation that is compatible with both operating environments.

17. The computer program product according to claim 13, wherein the user interface implementation defines both presentation and logics for the user interface.

18. The computer program product according to claim 13, wherein the language structure also comprises data structures.
